(19) United States
(12) Patent Application Publication
(10) Pub. No.: US 2008/0114665 A1
(43) Pub. Date: May 15, 2008

(54) LICENSING SYSTEM

(76) Inventor: Kamia J. Teegarden, Oakland, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/936,052

(22) Filed: Nov. 6, 2007

Related U.S. Application Data
(60) Provisional application No. 60/865,384, filed on Nov. 10, 2006.

(51) Int. Cl. G06Q 30/00; G06Q 99/00

(52) U.S. Cl. 705/26; 705/1

(57) ABSTRACT

At least one embodiment of the present invention pertains to a process to: 1) license songs from copyright owners (licensors) for use by DJs (licensees) for inclusion in their mix compilations, such as using a single license for one or more mix compilations; 2) allow DJs to create and sell mixes using such songs; and 3) allow mix purchasers to purchase such mixes.

### CROSS-REFERENCE TO RELATED APPLICATION

This application claims the benefit of the earlier filing date of co-pending U.S. Provisional Patent Application No. 60/865,384, filed Nov. 10, 2006, and incorporated herein by reference.

### BACKGROUND

1. Field

Licensing songs from licensors for use by licensees for inclusion in the licensees' mix compilation

2. Background

The disk jockey (DJ) industry suffers from the difficult, and sometimes impossible, obstacles that the DJ must overcome in order to legally duplicate the DJ's mix compilations. A typical DJ mix compilation (e.g., a “mix”) will contain 15 to 20 songs, all of which need a separate license agreement, from their respective licensor, in order to legally be included in a DJ's mix for sale. A process to obtain and administer (e.g., according to sales of the mix) such separate or individual licenses, may involve contact with 15 to 20 different licensors in as many as 10 different countries, speaking as many as five different languages. This process is cost and/or time prohibitive and cumbersome to the point where it prevents most DJs from obtaining licensing. Thus, mixes may be created without some or all of the songs being licensed, resulting in the replication of unlicensed (and/or unauthorized) material (which may lead to claims of copyright infringement), or it results in the mix compilation simply never being made.

In addition, the current licensing processes create large obstacles for licensors who wish to license their songs to DJs for mix compilations. Because of the difficulties that DJs face in obtaining licensing, licensors, who create the songs that the DJs wish to license, miss a significant number of possibilities and opportunities for distributing and sale of their work. Another difficulty is that the licensor must also administrate the separate licensing and royalty agreements with each DJ who wishes to use each song. For a popular song, this could mean creating at least 20 to 30 different licensing agreements, which is cumbersome and time consuming; this limits the profitability of the licensor because of all the redundant legal agreements, accounting, and negotiating they have to execute in order to license their songs.

### SUMMARY

At least one embodiment of the present invention pertains to a process to: 1) license songs from copyright owners (licensors) for use by DJs (licensees) for inclusion in their mix compilations, such as using a single license for one or more mix compilations; 2) allow DJs to create and sell mixes using such songs; and 3) allow mix purchasers to purchase such mixes.

### BRIEF DESCRIPTION OF THE DRAWINGS

Embodiments are illustrated by way of example and not by way of limitation in the figures of the accompanying drawings in which like references indicate similar elements. It should be noted that the references to “an” or “one” embodiment of this disclosure are not necessarily to the same embodiment, and such references mean at least one.

FIG. 1 is a flow diagram of a process to obtain songs to make a mix, in accordance with an embodiment.

FIG. 2 is a flow diagram of a process to identify songs and starting times of songs in a mix, in accordance with an embodiment.

FIG. 3 shows an example of a network environment, for use in an embodiment.

FIG. 4 is a block diagram showing an architecture of a server, for use in an embodiment.

### DETAILED DESCRIPTION

Embodiments described herein pertain to a method, apparatus, process, server, and system to license songs from copyright owners (licensors) for use by DJs (licensees) for inclusion in their mix compilations (such as to be sold to mix purchasers). The invention may use a computer, such as a server computer or “host” coupled to the Internet as a central point (e.g., by hosting a website on the server computer) that can be accessed by the copyright owners, DJs, and/or mix purchasers (e.g., accessed using client computers or computing devices also coupled to the Internet).

According to embodiments, the licensor signs one licensing agreement that licenses their songs to multiple DJs for use in and sale of multiple mix compilations. Additionally, the licensing process facilitates and executes the administration of royalty tracking, sales, statements and payments. For the DJ, embodiments provide one central point (e.g., a website on a host computer) of licensing (such as using a single license for one or more single mix compilations) for a large library of songs, bypassing the typically difficult process of obtaining, and administrating multiple licenses from multiple licensors. The DJ simply has to make a mix compilation with the licensed songs (e.g., the songs for at least a single mix compilation are automatically licensed to the DJ by the system in a single license), deliver the sound recording to the host system, and tell the system some information (e.g., as metadata) about the mix compilation (such as songs used, length of time the song was used, genres, etc.). The embodiments change what normally takes weeks, or sometimes months to obtain licenses, to only taking minutes. This radically simplified and automated mix compilation licensing process makes possible a new market by facilitating creation and sale of mixes or compilations that were not previously commercially viable.

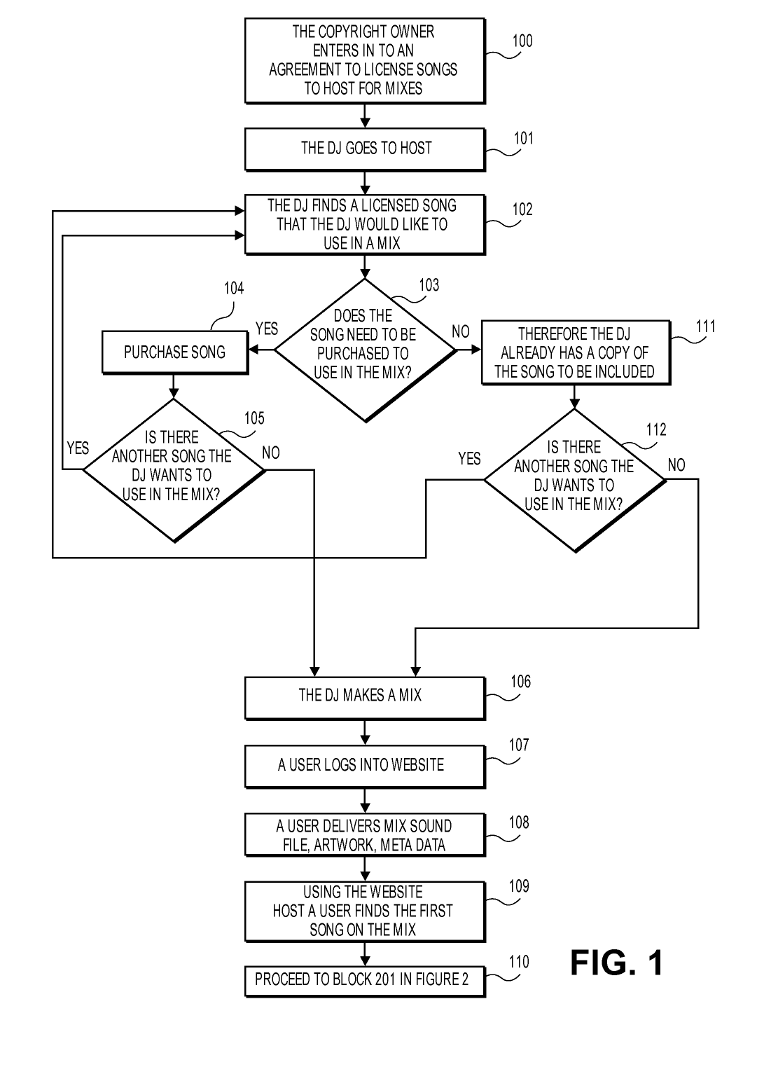

FIG. 1 is a flow diagram of a process to obtain songs to make a mix, in accordance with an embodiment of the invention. In some cases, the process of FIG. 1 may be described as including delivering the mix (e.g., see block 108). At block 100 the licensor (copyright owner) enters into an agreement with the host (e.g., DanceRecords.com) that licenses their songs for use by multiple DJs (e.g., users) in multiple mix compilations that will be offered for sale on the host (e.g., DanceRecord.com). At block 101, the DJ goes to or accesses the host (e.g., DanceRecords.com). At block 102 the DJ then finds (e.g., selects) a licensed song (e.g., licensed to the host by the copyright owner and licensable to the DJ by the owner or host) that the DJ would like to use in a mix. The song may be found/selected by reviewing a list identifying licensed songs or searching a database identifying licensed songs using a search engine. If at block 103, if the DJ does not own the song already (e.g., if the DJ has not previously purchased the song, such as on a CD, vinyl record, or as a music download), the DJ may (or will need to in some embodiments) purchase the song at block 104. Then, at block 105, the DJ decides if there is another song the DJ wants to use in the mix. If the answer is yes, the DJ goes back to block 102. If at block 105 the DJ decides that there is not another song that the DJ wants to use in the mix and the DJ moves on to block 106 and makes a mix of or including the songs.

At block 103, if the song does not need to be purchased, the DJ continues on to block 111 because the DJ already owns (e.g., has legally purchased) a copy of the song. Therefore, the process moves on to block 112. At block 112, the DJ to decides if he or she would like to use another song in the mix. If the DJ does want to add another song, he or she can go back to block 102 and start again. If the DJ is finished finding/selecting songs, the process then moves on to block 106, where the DJ makes a mix compilation (e.g., a mix) of or including the licensed songs.

Making a mix may also include downloading songs from a server (in compressed or non-compressed digital data format) as described herein. Making the mix may include identifying songs (e.g., by title, etc.), song order (e.g., the order in which the songs are arranged and/or to be played) and song start times for a mix compilation as described herein. Making a mix compilation may include “mixing” songs or blending ending and introductions of adjacent songs.

A mix compilation, representatively, may include between 2 and 200 songs, some or all of which may or may not be related. The songs may be related because they are songs intended for use at or during certain settings (e.g., during working out/, running, cleaning, driving, etc.) or events (e.g., social events). For instance the songs may be for use at or during dancing. (e.g., as part of a dance mix), parties, weddings, clubs (e.g., songs for playing in clubs, such as dance clubs), etc. Similarly, the songs may be related because they are have the same or a similar genre, such as electronics, hip-hop, rap, rock, heavy metal, country, easy listening, classical, pop, alternative, reggae, soundtrack songs (e.g., movie or television), holiday songs, children's songs, alternative, jazz, blues, etc. Also, the introduction and/or ending portion of a song may be related to the ending portion of the prior song and/or introduction of the next song, as noted about and/or by the portions having a similar sound, melody, rhythm, etc. There may or may not be a “break” (e.g., a period of silence or without any song or sound) between adjacent songs. In some cases, there may be a transition between adjacent songs, where the end portion (or any portion) of a prior song is blended (e.g., by having a similar sound, melody, rhythm, etc.) into the introduction (or any portion) of the next song. Some mix compilations may be described as having songs or music that will complement the prior song or songs. In addition, the mix may progress from song to song, as a kind of music journey that goes somewhere (e.g., along a logical, musical, lyrical, and/or emotional path or progression from one “point” or an origin to another point or a termination). Some mix compilations may be described as having songs or music that segues seamlessly from song to song. Factors to evaluate whether the songs are complementary, progress, or have a segue may include considering, comparing, or accounting for the content of the lyrics, subject of lyrics, genre of the music, pitch, tone, melody, harmony, form, rhythm, tempo, meter and/or the like of the songs. For example, a DJ may desire to create or provide a mix having songs, where each song complements the prior song.

In some cases, blocks 101, 102, 104 and/or 105 are optional. For instance, a DJ may create a mix, without accessing the host, such as where the DJ knows when mixing whether the songs on the mix are licensed to the host, or licensable to the DJ at the host.

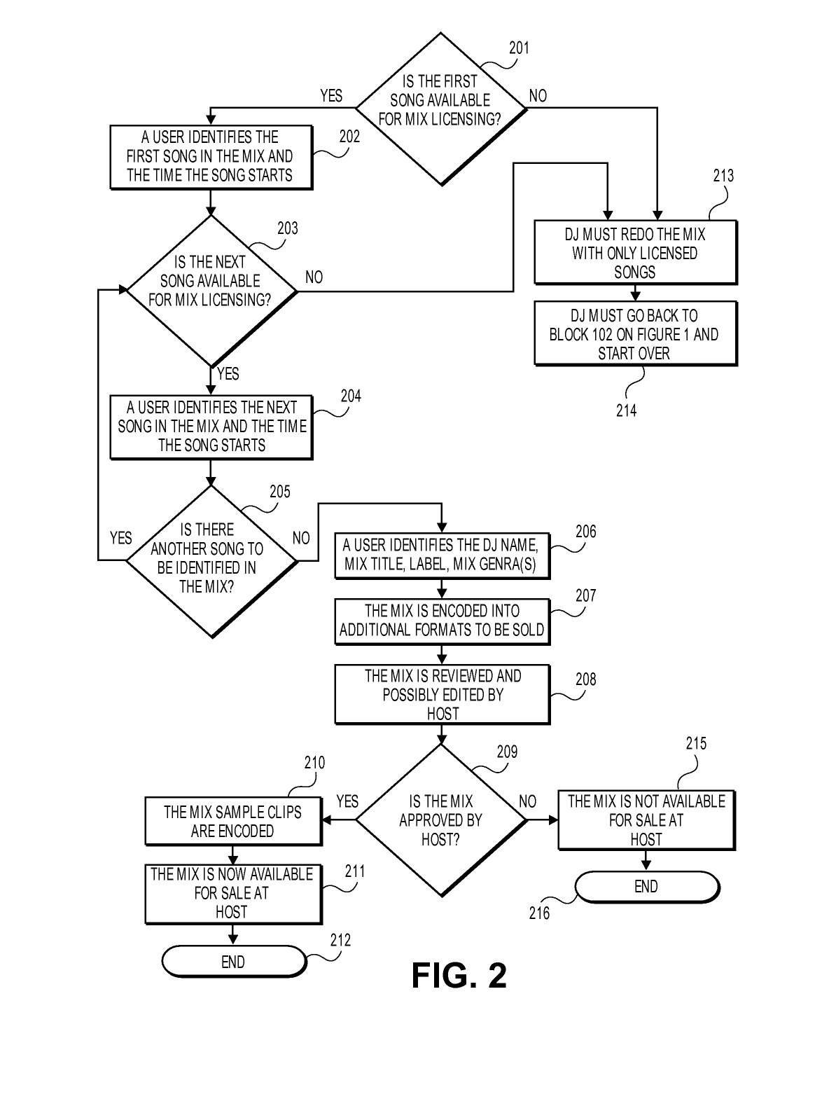

After the DJ has made a mix, the process goes to block 107 where a user (e.g., the DJ) may log into the host (e.g., provide a username and password to the hosted website). The “user” may or may not be the “DJ” of another block. In some cases the “user” may not be a DJ, “mix artist” or “mix DJ”. Also, block 107 may be omitted, such as where it is not necessary for the user to log into the host; where other security and/or user identification measures are used; or where the user otherwise provided appropriately secure and/or identifying access to the host to perform the other blocks/processes described herein. Then, at block 108, a user (e.g., the DJ) delivers the mix compilation sound file, artwork, and Metadata to the website, such as by uploading, attaching to an email or otherwise sending one or more files (or causing the server to access the files) including digital audio (compressed, MP-3, or non-compressed). In some embodiments, at block 108 the mix compilation sound file is delivered, but the artwork, and Metadata are excluded from delivery. Also, in some embodiments, at block 108 the mix compilation sound file and artwork are delivered, but the Metadata is excluded from delivery. At block 109, using the host (e.g., the website DanceRecords.com), a user (e.g., the DJ) finds (e.g., identifies or selects as noted for block 102) the first song of the mix as a song licensed to the host, or licensable to the DJ at the host. For example, the server or website identifies the song selected by the DJ as a licensed song (e.g., licensed to the host by the copyright owner and licensable to the DJ by the owner or host). At block 110 the process proceeds to block 201 in FIG. 2.

FIG. 2 is a flow diagram of a process to identify songs and starting times of songs in a mix, in accordance with an embodiment of the invention. The process or blocks of FIG. 2 may be combined or separate from those of FIG. 1. For instance, FIGS. 1 and 2 may be parts of the same process flow, where FIG. 2 is a continuation of FIG. 1 (e.g., see block 110). Alternatively, block 110 may be omitted and/or the process of FIG. 1 may be performed without performing the process of FIG. 2, and vice versa. In some cases, a process to identify songs and starting times of songs in a mix includes blocks 107-206. At block 201, if the first song is available for the mix licensing (e.g., if so, song one has been licensed by the copyright owner to the host, and is and licensable to the DJ by the owner or host for use in a mix sellable to a mix purchaser), the process moves on to block 202. At block 202 a user (e.g., the DJ) identifies to the host, the first song in the mix and the time the song starts. At block 203, a user checks to see if the next song is available for mix licensing (e.g., a process similar to that of block 201, but checking for the next song instead of the first song). If the answer is yes, at block 204, a user (e.g., the DJ) identifies the next song in the mix and the time to song starts (e.g., a process similar to that of block 202). At block 205, a user identifies if there is another song in the mix. If there is another song to identify, the user goes back to block 203. If there are no other songs to identify and then the process moves on to block 206.

If the first song is not available for mix licensing at block 201, the process goes to block 213 and the DJ (or user) may (or must in some embodiments) redo the mix with only licensed songs. At block 214, the DJ (or user) may (or must in some embodiments) go back to block 102 where the DJ finds a licensed song that the DJ would like to use in a mix. Blocks 213 and 214 are options. For instance, a mix may be created where not all of the songs are licensed/licensable by the copyright owners that have agreements with the host. However, the DJ may have a valid license for those songs from another source, such as an individual license for the song or songs not available in block 201. In this embodiment, blocks 213 and 214 can be replaced by a block where the DJ (or user) indicates to the host and/or provide information/evidence of such license. Then the process continues to block 203.

After a user identifies each song and makes sure that the songs are available for mix licensing, in blocks 202, 203, 204, and 205, the process goes to block 206 where a user (e.g., the DJ) submits the DJ name, mix title, label, and mix genre(s). Submission of some or all of the information at Block 206 is optional as this information may have been provided during log in (block 107) or may be otherwise obtained by the host. Also, block 206 may be omitted, such as where this information is not necessary or used to perform the other blocks/processes described herein.

At block 207 the mix is encoded into additional formats (e.g., compressed, MP-3, non-compressed, and like formats for digital audio) to be sold (e.g., to mix purchasers). Block 207 may include a user, the host, and/or the DJ causing the mix to be encoded (e.g., by or at the host). At block 208, the mix data is reviewed and possibly edited by the host (e.g., DanceRecords.com). Review may include determining whether any or all songs in the mix are validly (e.g., legally) licensed/licensable by the copyright owners that have agreements with the host. Review may include determining whether the DJ may have a valid license for those songs from another source. Also, editing may include correcting audio errors and/or re-mixing the original mix (e.g., mixing the same, more or less songs as the original mix). In some cases, editing will include removing from the mix, songs that are not licensed/licensable by the copyright owners that have agreements with the host (and optionally, removing songs for which the DJ may have a valid license from another source). Also, in some embodiments, editing may include correcting the track times and or changing Metadata.

At block 209, the host (e.g., DanceRecords.com) approves or does not approve the mix. Approval may be provided when all of the songs of the mix (or re-mix) are licensed/licensable by the copyright owners that have agreements with the host (and optionally for which the DJ may have a valid license from another source). Approval may also require that all the songs of the mix were purchased from the host (e.g., see block 14). Approval may also require approval of the DJ (by name or otherwise), title, label and/or mix genre (e.g., to preclude illegal, offensive, obscene or disparaging material or terms). In some cases, approval may require approval of the track times and or Metadata. If the mix is approved, at block 210, the host (e.g., DanceRecords.com) encodes the mix sample clips (e.g., into compressed, MP-3, non-compressed, and like formats for digital audio). Then, at block 211, the mix is now made available for sale at the host (e.g., for sale to mix purchasers, at a website of the host, by the DJ or by DanceRecords.com for the DJ). At block 212, the process is ended. If at block 209 the host (e.g., DancRecords.com) does not approve the mix, at block 215, it is not provided/available for sale at the host (e.g., it is not listed at DanceRecords.com for purchase and the DJ may or may not be notified of this fact). At block 216 the process is ended.

According to embodiments, not all of the blocks of FIG. 1 and/or 2 need to be practiced. Specifically, in some embodiments, blocks 207-216 are optional. Any or all of those blocks may not be practiced in some cases. For instance, a user, DJ or host may not provide mixes for sale at a host website. In this case, the host may be used to purchase the songs and/or to obtain (and optionally administer) licenses for the mix, without selling the mix. Also, block 202 may not be practiced, such as where a user does not identify and/or the website does not ask the time some or all songs start (e.g., start time) in the mix. Instead, the single license to the DJ (and or licenses obtained by the host) may be for or include agreements for using entire songs (e.g., the whole song including all portions), and/or costs for entire songs for a mix. In these cases, the cost may or may not consider statistics, averages, marketing data, or other indications of how much of the entire song a DJ typically uses in a mix. For instance, if 90 percent of a specific song (or of all songs for a license) is typically used, the cost may be 90 percent of a usual cost (e.g., as determined by the market and/or other such licensing agreements) to license the entire song. Alternatively, regardless of how much of a song is typically used in a mix, the cost may be the same for a song or for all songs, such as by being the usual cost for using the entire song in a mix. Such licenses may be described as, or may be an offer for an “untracked mix” for sale.

In some embodiments, block 206 may be performed at or after block 107 or 108, instead of at block 206 (e.g., move block 206 to a position in the process just after block 107 or 108). In some cases, block 206 may be performed at or after block 107 or 108, and the information identified may be confirmed at block 206. In some embodiments, block 207 may be performed at or after block 210, instead of at block 207. In some cases, block 207 may be performed at block 207, as shown, as well as at or after block 210.

According to embodiments, the term “DJ” may describe any user of the website, server or system that may or may not be a DJ. Similarly, reference to a “user” may or may not refer to a DJ. In some cases, reference to a “DJ” or “user” (e.g., herein and/or in FIGS. 1-2) may refer to a different person than an earlier, later or other reference to a “DJ” or “user”. This same concept also applies to reference to a copyright owner and/or a mix purchaser. The host, may be the same website, server, or an owner thereof, for all blocks.

For instance, with respect to use of the term “user”, although blocks 107, 108, 109, 202, 204 and 206, are labeled with and are described for a “user”, that user may or may not be a DJ. Also, a “user” for any of those blocks may be the same or a different user than that of another block. Thus, a “user” who may or may not be a “mix artist” or “mix DJ” could perform the process of any or all of those blocks. In fact, if the “user” in any or all of those blocks may be the same DJ or a different DJ than a user or DJ of another of those blocks. For instance, a DJ (e.g., mix artist) may only be needed or perform the process of song selection for a mix (e.g., blocks 102, 105, 111, and 112) and mixing of the songs (e.g., block 106). However, someone else (e.g., the same or different “users” other than the DJ) could log into the website, deliver the mix and/or metadata and track the mix (e.g., blocks 107, 108, 109, 202, 204 and/or 206). Of course, the same DJ (or different DJs) could perform the process of any or all of the blocks labeled with “DJ” and “user”.

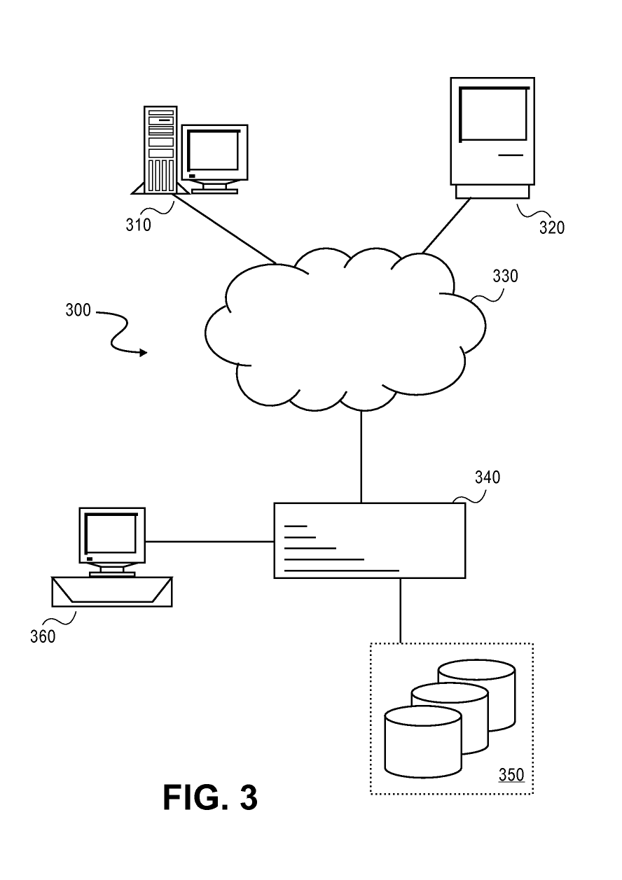

FIG. 3 shows an example of a network environment, for use in an embodiment of the invention. FIG. 3 shows a simple example of a network environment 300, containing computers 310 and 320, which act as clients of server 340. The clients communicate with the server through a medium such as network 330. Computer system 360 may be useful to configure, monitor, or manage server 340. Server 340 may provide data storage services to its clients, such as using disks 350.

Network 330 may be or include a local area network (LAN), intranet, wide area network (WAN), a global area network (GAN) such as the Internet, and/or various other networks over which data is communicated using wired optical, wireless, acoustical, electromagnetic radiation, or other medium as known in the art. Also, computers 310 and 320 may be, for example, a desktop computer, a laptop computer, a hand held computing device, a personal computer (PC), work station, electronic device, computational device, electrically operated machines, such as general-purpose and special-purpose computing devices (e.g., “computers”) for mixing digital audio files (e.g., in compressed, MP-3, or non-compressed formats), data storage devices or systems typically including computer processors and other devices (often operating under the control of a processor) that frequently need to store information in, or retrieve information from a computer memory, or the like, as known in the art.

Server 340 may represent a data storage device, storage, server, network server, file server, where reading data from mass storage devices (e.g., disks 350) and writing data to mass storage devices of the server is controlled by an operating system (OS). Specifically, server 340 may control one or more storage subsystems, such as disks 350. A storage subsystem may include one or more mass storage devices, disk arrays, mass storage devices organized into one or more volumes of a RAID, storage facilities, and/or non-volatile storage facilities. Each mass storage device may be, for example, a conventional magnetic disk, an optical disk such as a compact disk-read only memory (CD-ROM), or digital video disk (DVD) based storage, magneto-optical (MO) storage, or any other type of non-volatile storage devices as known in the art. Specifically, disks 350 may include one or more mass storage devices and may be considered “a storage subsystem” for server 340.

According to some embodiments, it is also contemplated that server 340 may be a computing device, such as a general purpose computing device and/or special purpose computing device, a data storage device and/or system, a network server, a network-based storage environment and/or device, a file server, an Internet server, computer 310, a desktop computer, a portable computing device, a handheld computing device, a telephone, a cellular telephone, a gaming device, an Internet related computing device, a digital video disk (DVD) player, a set top box, etc., and/or another device or system that may access or include a cache memory to provide quick read and write access to data frequently or recently used. In other words the concepts described herein for server 340 may also be applied to computing devices, other than “servers”, that provide the functionality described for server 340.

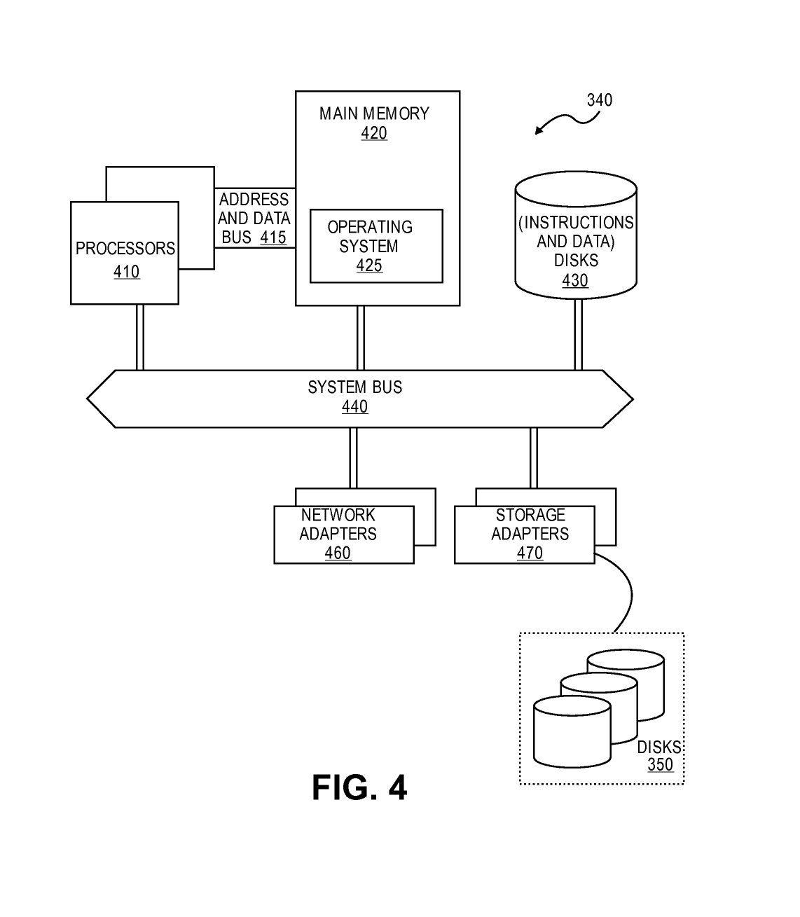

Server 340, may be a storage server having a storage subsystem (e.g., disks 350), main memory, and cache memory to store and retrieve data on behalf of one or more client processing systems (clients). For instance, FIG. 4 is a block diagram showing an architecture of server 340 and some components thereof, according to certain embodiments of the invention. Certain standard well-known components, which are not germane to the present invention, may not be shown. Server 340 includes components, such as one or more processors 410, and memory 420 coupled to system bus 440. Bus 440, shown in FIG. 4, is an abstraction that represents any one or more separated physical buses and/or point-to-point connections, connected by appropriate bridges, adapters and/or controllers. Bus 440, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”). In some cases, bus 440, is a host bus, such as a bus to interface a host (e.g., processors 410) to peripheral devices (e.g., disks 350).

Processors 410 may be the central processing units (CPUs) of server 340 and, thus, control and coordinate the overall operation of the server. In certain embodiments, the processors 410 accomplish this by executing software, such as operating system 425 stored in memory 420. A processor of processors 410 may be, or may include, one or more programmable general-purpose or special-purpose microprocessors, digital signal processors (DSPs), programmable controllers, application specific integrated circuits (ASICs), programmable logic devices (PLDs), the like, or a combination of such devices.

Memory 420 may be or include the “main memory” of server 340. Memory 420 represents any form of random access memory (RAM), read-only memory (ROM), flash memory, or the like, or a combination of such devices. Memory 420 may include various types of RAM memory as known in the art. Processors 410 have direct access to main memory 420 via an address and data bus 415 as know in the art.

Also connected to processors 410 through bus 440 are disks 430, storage adapters 470 and network adapters 460. Disks 430 may be one or more internal mass storage devices including any conventional medium for storing large volumes of data in a non-volatile manner, such as describe above for disks 350 (e.g., one or more magnetic or optical based disks). Disk 430 may contain other instructions and data that are not immediately required by the system in its operations.

Network adapters 460 provide the server with the ability to communicate with remote devices, such as the computers 310 and/or 320, over a network (e.g., network 330) and may be, for example, an Ethernet adapter or Fibre Channel adapter (e.g., in a SAN implementation). Storage adapters 470 allow the server to access storage subsystems, such as disks 350, and may be, for example, a Fibre Channel adapter or a SCSI adapter. Thus, server 340 can communicate with its clients through network adapters 460, and with its mass storage devices (such as disks 350) through storage adapters 470.

For instance, storage adapters 470 and network adapters 460 may have input/output hardware, adapters, or connectors (e.g., described herein as an I/O) for communicating data between disks 430 and/or disks 350, and remote devices (e.g., client computers). During such communication, portions or all of the data being communicated may be “cached” in a cache memory, which may or may not be part of main memory 420. Data that is cached may be data that is frequently or recently used when reading data from and writing data to a storage system and/or subsystem (e.g., when server 340 is reading data from and writing data to the drives of disks 350 and/or 430).

Operating system 425 may be or be built “on top of” a conventional OS, such as disk operating system (DOS), Windows, Unix, Linux, OS/2, OS/9, Xenx, etc. as known in the art. For instance, operating system 425 may include an operating system such as WINDOWS XP®, or another WINDOWS® operating system by Microsoft Corporation of Redmond, Wash. Operating system 425 may also include a MACINTOSH® operating system by Apple Computer of Cupertino, Calif.

Moreover, server 340 may include, store, load, and execute (e.g., run) computer programs/instructions, operating system 425, a file system, other software applications, and/or a sequence of instructions to: 1) license songs from copyright owners (licensors) for use by DJs (licensees) for inclusion in their mix compilations; 2) allow DJs to create and sell mixes using such songs, such as using a single license for one or more mix compilations; and/or 3) allow mix purchasers to purchase such mixes as described herein (e.g., see FIGS. 1-2).

The application or sequence of instructions may be a separate application from or may be part of operating system 425. Also, operating system 425 and/or another software application to perform the functions described herein may be loaded into memory 420, such as from a storage system like disks 430 (or in some embodiments from a storage subsystem such as disks 350), and launched after power on self test (POST), boot-up, or initialization of server 340. Operating system 425 and/or another software application to perform the functions described herein may each be a set of one or more programs, which control server 340's operation, the allocation of resources, and the communication of data. For instance, such functions include those to: 1) license songs from copyright owners (licensors) for use by DJs (licensees) for inclusion in their mix compilations, such as using a single license for one or more mix compilations (e.g., for one, two, three, four or more mix compilations); 2) allow DJs to create and sell mixes using such songs; and 3) allow mix purchasers to purchase such mixes.

Specifically, operating system 425 may include or access a machine accessible medium (e.g., disks 350 and/or 430) containing a sequence of instructions that when executed by a processor (such a processors 410) cause server 340 to provide a method, apparatus, process, server, and system to: 1) license songs from copyright owners (licensors) for use by DJs (licensees) for inclusion in their mix compilations, such as using a single license for one or more mix compilations; 2) allow DJs to create and sell mixes using such songs; and 3) allow mix purchasers to purchase such mixes.

According to embodiments, copyright owners (e.g., a license or contract party) may sell, offer to sell, offer to offer to sell, license, offer to license, offer to offer license multiple songs to multiple song purchasers and/or licensors. The copyright owners may go to the website (e.g., DanceRecords.com) of a host/server. For example, the server may provide the copyright owners (e.g., artist, musicians, bands, record companies, licensing organizations or companies, strategic marketing groups such as Broadcast Music Inc., and the like) with licensing agreements to sell and/or license multiple songs to multiple DJs for use in and sale of mix compilations, such as to allow the DJ to “automatically” obtain a single license for at least one single mix compilation. These agreements may be accessed, obtained, reviewed, edited, and executed (e.g., as digital files, such as word processor documents) at server 340 by the owner, on-line at client computer 310. These licensing agreements may be between the copyright owners and the DJs, or between the copyright owners and the host. Legal relations, licenses, contract between the host and other parties may be with respect to the owner of the host. Similarly, actions by or occurrences on/at the host may be caused by the owner, agents, or technicians of the host. For example, a single licensing agreement may license songs from copyright owners (licensors) for use by DJs (licensees) for inclusion in their mix compilations, such as using a single license for one, two, three, four or more mix compilations. Thus, in some cases, a DJ may use one agreement to make a number of mixes the DJ desires, selects, or predetermines. In fact, after creating a predetermined number of mixes, using a single license, the DJ may add one or more additional mixes to the predetermined number of mixes using the same license. This may occur without the system, website or copyright owners requiring a new agreement with the DJ (e.g., without requiring an additional agreement for any of the additional mix compilations.

DJs (e.g., a license or contract party) may purchase, accept an offer to sell, accept an offer to offer to sell, obtain a license, accept an offer to obtain a license, and/or accept an offer to offer to obtain a license of multiple songs (such as to allow the DJ to “automatically” obtain a single license for one or more single mix compilations). The DJs may go to the website (e.g., DanceRecords.com) of a host/server. For example, the server may provide DJs with identification of, access to, purchase of, and/or license of songs and/or portions of songs for use in a mix to be sold. The songs and/or license agreements may be identified (e.g., from lists), accessed, obtained, reviewed, and executed from/at server 340 by the DJ, on-line at client computer 310. The songs may be listed, purchased, accessed, listened to, and/or obtained as digital files or digital music (e.g., in a compact disk, compressed, MP-3, or like format). The songs may be mixed at or on the server, or downloaded to an analog mixer and/or another computing device, such as a client computer (e.g., for mixing). For example, the DJ (e.g., a mix artist, “mixer”, or mix compilation creator) may create or “mix” the mix compilation using or “on” an analog mixer and/or a computing device such as a desktop computer, a laptop computer, a hand held computing device, a personal computer (PC), work station, electronic device, computational device, electrically operated machines, such as general-purpose and special-purpose digital audio mixing or computing device (e.g., “computer”) for mixing digital audio files (e.g., in compressed, MP-3, or non-compressed formats). The computing device may include a computer processor, a memory, and other devices (often operating under the control of a processor) that frequently need to store information in, or retrieve information from a computer memory, or the like.

The purchase and/or license agreements may be accessed, obtained, reviewed, edited, and executed (e.g., as digital files, such as word processor documents) from/at server 340 by the DJ, on-line at client computer 310. These licensing agreements may be between the DJs and the copyright owners, or between the DJs and the host or owner of the host (such as to allow the DJ to “automatically” obtain a single license for at least one mix compilation). Also, DJs may sell, offer to sell, and offer to offer to sell mixes to mix purchasers. For example, the server may provide mix purchasers with identification of, access to, listening to, purchase of, and license of mixes and/or portions of mixes to be sold.

Mix purchasers (e.g., a license or contract party) may purchase, accept an offer to sell, and/or accept an offer to offer to sell a mix. The mix purchasers may go to the website (e.g., DanceRecords.com) of a host/server. For example, the server may provide mix purchasers with lists of, identification of, access to, listening to, and/or purchase of the mix (e.g., provided at server 340 to the mix purchaser, on-line at client computer 320). The mixes may be listed, purchased, accessed, listened to, and/or obtained as digital files or digital music (e.g., in a compact disk, compressed, MP-3, or like format). The mixes may be downloaded to another computing device, such as a client computer 310. Agreements to purchase the mixes may be between the mix purchasers and the DJs, or between the mix purchasers and the host or owner of the host.

Thus, the copyright owners, the DJs and/or the purchasers may be considered “users” of the method, apparatus, process, server, and/or system described herein. For example, they may be users, license parties, and/or contract parties of the website (e.g., DanceRecords.com) of host/server 340.

According to embodiments, a multiple song license (e.g., a single license to the DJ for at least one single mix compilation) from a copyright owner of multiple songs to license multiple songs in multiple single licenses to multiple of mix creators to create and sell multiple mix compilations including the multiple songs or a number of the songs of the multiple songs is created, provided, and/or executed (e.g., by a host or user of a website of the host). Multiple song licenses are considered, such as to allow mix creators to create a mix having some songs from more than one of the multiple song licenses. Parties to the multiple song and/or single licenses may be a copyright owner, a host and/or a DJ. Embodiments also include creating, providing, and/or executing (e.g., by a host or user of a website of the host) a single license to a mix creator to license multiple songs for creation and sale of a mix compilation. Parties to the single licenses may be a host and/or a DJ. In some cases, a mix compilation including only the multiple songs is created, mixed, and/or uploaded to a server, such as by a DJ or user of a website of the server. Also, the multiple songs and starting times of the multiple songs may be identified, such as to a website (e.g., to a host by user of a website of the host). It is also considered that the license from a copyright owner of the multiple songs to license the multiple for multiple mix compilations to be created by multiple mix creators may be administrated, monitored or tracked. Administration may include calculating and/or providing royalty payments to the copyright owner (e.g., for single licenses and/or DJ for sales of the mix). The administrating may include accounting for, calculations including, and/or consideration of the identified multiple songs and starting times of the multiple songs. Administration may be performed by a host, host website, and/or user of the website. Parties to the administration may be a copyright owner, a host and/or a DJ. The mix may be offered for sale, such as on a website of a host for purchase by mix purchasers. Parties to the offer for sale may be a mix purchaser, a host and/or a DJ. In some cases, administration may include accounting for sales of the mix.

It can be appreciated that embodiments of the invention create or increase a new licensing market that is an improvement over the current licensing model. Also, embodiments of the invention create or increase a size of a large library containing licensed songs that are available for use in mix compilations automatically. Moreover, embodiments of the invention delete or reduce the need for multiple licenses for each mix compilation. Next, embodiments of the invention delete or reduce the administration of multiple licensing agreements and multiple royalty negotiations and deals for both the licensor and the DJ. Similarly, embodiments of the invention create or increase a licensing process that saves a significant amount of time for DJs and licensors. Likewise, embodiments of the invention create or increase new opportunities for DJs and licensors to obtain royalties and market their work. In addition, embodiments of the invention delete or reduce potential copyright infringement through the creation of a simplified licensing process.

Embodiments of the invention include a website or computer providing a single license to a mix creator to license a plurality of songs for creation and sale of a mix compilation. In addition, embodiments may include a website or computer obtaining a multiple song license from a copyright owner of a plurality of songs to license the plurality of songs in a plurality of single licenses to a plurality of mix creators to create and sell a plurality of mix compilations including the plurality of songs. Some embodiments may include a website or computer creating a mix compilation including only the plurality of songs; identifying the plurality of songs and starting times of the plurality of songs; and/or offering the mix compilation for sale. Some embodiments may include a website or computer administrating a multiple song license from a copyright owner of the plurality of songs to license the plurality of songs for a plurality of mix compilations to be created by a plurality of mix creators, wherein administrating includes consideration of the identified plurality of songs and starting times of the plurality of songs. The plurality of songs and starting times may be identified (e.g., by a user) to a website. The offer for sale may be on a website for purchase by mix purchasers.

Moreover, some embodiments may include a website or computer receiving from a mix creator at a website, identification of a plurality of songs for creating a mix compilation including only the plurality of songs; and/or providing at the website, a single license to the mix creator to license the plurality of songs for creation and sale of the mix compilation. The website or computer may also automatically licensing at the website, using the single license, the plurality of songs from one of a host of the website and a plurality of song copyright owners.

The website or computer may perform the acts or processes described herein based, using or by executing a machine-accessible medium (such as a computer RAM memory, hard drive, CD, DVD, etc.) containing instructions that, when executed, cause a machine (the computer or website) to perform the acts or processes.

Providing the license may include automatically providing at the website, a single license to the mix creator to license the plurality of songs for creation and sale of the mix compilation; and/or automatically licensing at the website, using the single license, the plurality of songs from one of a host of the website and a plurality of song copyright owners.

Also, administrating a multiple song license may include administrating the license from a copyright owner of the plurality of songs to license the plurality of songs for a plurality of mix compilations to be created by a plurality of mix creators, wherein administrating includes consideration of the identified plurality of songs and starting times of the plurality of songs

Use of “automatically” herein, such as to automatically license or administrate may describe an act or a process that does not include human intervention, input or control by anyone or by more than one person. For example, such a process may be performed by a computer or performed according to software being executed by a machine or computer. In some embodiments, “automatically” may describe an act or process that involves input or action by only one person or party. For example, a user of a website or computer may provide input, and in response the website or computer may automatically provide a license and/or administrate a multiple song license.

In the foregoing specification, specific embodiments are described. However, various modifications and changes may be made thereto without departing from the broader spirit and scope of embodiments as set forth in the claims. The specification and drawings are, accordingly, to be regarded in an illustrative rather than a restrictive sense.

What is claimed:

1. A method comprising:
providing a single license to a mix creator to license a plurality of songs for creation and sale of at least one mix compilation.

2. The method of claim 1, further comprising:
obtaining a multiple song license from a copyright owner of a plurality of songs to license the plurality of songs in a plurality of single licenses to a plurality of mix creators to create and sell a plurality of mix compilations including the plurality of songs.

3. The method of claim 1, further comprising:
creating a mix compilation including only the plurality of songs.

4. The method of claim 3, further comprising:
identifying the plurality of songs and starting times of the plurality of songs.

5. The method of claim 4, wherein the plurality of songs and starting times are identified to a website.

6. The method of claim 4, further comprising:
administrating a multiple song license from a copyright owner of the plurality of songs to license the plurality of songs for a plurality of mix compilations to be created by a plurality of mix creators, wherein administrating includes consideration of the identified plurality of songs and starting times of the plurality of songs.

7. The method of claim 3, further comprising:
offering the mix compilation for sale.

8. The method of claim 7, where the offer is on a website for purchase by mix purchasers.

9. A method comprising:
receiving from a mix creator at a website, identification of a plurality of songs for creating a mix compilation including only the plurality of songs;
providing at the website, a single license to the mix creator to license the plurality of songs for creation and sale of the mix compilation.

10. The method of claim 9, further comprising:
automatically licensing at the website, using the single license, the plurality of songs from one of a host of the website and a plurality of song copyright owners.

11. The method of claim 9, further comprising:
obtaining a multiple song license from a copyright owner of a plurality of songs to license the plurality of songs in a plurality of single licenses to a plurality of mix creators to create and sell a plurality of mix compilations including the plurality of songs.

12. The method of claim 9, further comprising:
prompting at the website, the a mix creator to identify the plurality of songs and a song order.

13. The method of claim 12, further comprising:
automatically administrating at the website, a multiple song license from a copyright owner of the plurality of songs to license the plurality of songs for a plurality of mix compilations to be created by a plurality of mix creators, wherein administrating includes consideration of the identified plurality of songs and starting times of the plurality of songs.

14. The method of claim 12, further comprising:
offering the mix compilation for sale on a website for purchase by mix purchasers.

15. A machine-accessible medium containing instructions that, when executed, cause a machine to:
provide a single license to a mix creator to license a plurality of songs for creation and sale of at least one mix compilation.

16. The machine-accessible medium of claim 15, further comprising instructions that, when executed, cause the machine to:
provide the single license at a website having a host;
license, using the single license, the plurality of songs from one of the host and a plurality of song copyright owners.

17. The machine-accessible medium of claim 15, further comprising instructions that, when executed, cause the machine to:
obtain a multiple song license from a copyright owner of a plurality of songs to license the plurality of songs in a plurality of single licenses to a plurality of mix creators to create and sell a plurality of mix compilations including the plurality of songs.

18. The machine-accessible medium of claim 15, further comprising instructions that, when executed, cause the machine to:
create a mix compilation including only the plurality of songs;
prompt the a mix creator to identify the plurality of songs and a song order.

19. The machine-accessible medium of claim 18, further comprising instructions that, when executed, cause the machine to:
administrate a multiple song license from a copyright owner of the plurality of songs to license the plurality of songs for a plurality of mix compilations to be created by a plurality of mix creators, wherein administrating includes consideration of the identified plurality of songs and starting times of the plurality of songs.

20. The machine-accessible medium of claim 18, further comprising instructions that, when executed, cause the machine to:
offer the mix compilation for sale on a website for purchase by mix purchasers.
